(19) United States
(12) Patent Application Publication
(10) Pub. No.: US 2022/0221681 A1
(43) Pub. Date: Jul. 14, 2022

(54) OPTICAL ELEMENT HOLDER AND OPTICAL COMPONENT

(71) Applicant: SUMITOMO ELECTRIC FINE POLYMER, INC., Sennan-gun, Osaka (JP)

(72) Inventors: Shohei OKABE, Sennan-gun, Osaka (JP); Hiroki YAMANE, Sennan-gun, Osaka (JP)

(73) Assignee: SUMITOMO ELECTRIC FINE POLYMER, INC., Sennan-gun, Osaka (JP)

(21) Appl. No.: 17/607,764

(22) PCT Filed: May 28, 2020
(86) PCT No.: PCT/JP2020/021226

§ 371 Date: Oct. 29, 2021

(30) Foreign Application Priority Data
Jul. 23, 2019 (JP) 2019-135671

(51) Int. Cl. G02B 7/02; B29C 35/08; C03B 11/08

(52) U.S. Cl. CPC G02B 7/02; C03B 11/086; B29C 35/0805

(57) ABSTRACT

The optical element holder according to the present disclosure is an optical element holder for holding an optical element, wherein the optical element holder is formed from an optical element holder resin compound, the optical element holder resin compound contains a thermoplastic resin as a main component, a melting curve obtained by differential scanning calorimetry analysis of the optical element holder resin compound at a temperature increase rate of 10° C./min has two peaks in a range of not lower than 160° C. and not higher than 230° C. and a range of not lower than 260° C. and not higher than 320° C., and a ratio of a melting heat quantity in the range of not lower than 160° C. and not higher than 230° C. to a total melting heat quantity is not less than 20% and not greater than 80%.

### TECHNICAL FIELD

The present disclosure relates to an optical element holder and an optical component.

This application claims priority on Japanese Patent Application No. 2019-135671 filed on Jul. 23, 2019, the entire content of which is incorporated herein by reference.

### BACKGROUND ART

In recent years, optical fibers have been widely used in various electronic devices including communication means. An optical connector for connecting the optical fibers includes an optical component having a lens and an optical element holder which holds the lens and into and from which the optical fibers are inserted and pulled. To date, a method in which the optical element holder is formed from a material different from that of the lens, active alignment is performed, and then the lens and the optical element holder are assembled with an ultraviolet curable adhesive or the like, has been performed.

However, this assembly requires high accuracy, resulting in high cost. In addition, the adhesiveness between the optical element holder and the optical element during two-color molding may become insufficient, and misalignment or peeling may occur between the lens and the optical element holder due to the influence of the environment, so that the optical characteristics may be impaired. Therefore, in order to allow an optical component including an optical element and a holder formed from different materials to be mass-produced with excellent position accuracy and improve adhesiveness, a method in which crosslinking is performed after two-color molding of an optical element and a holder is performed has been proposed. According to this method, the optical element and the optical element holder are assembled at the time of molding the other, and no adhesive or assembly process is required. In addition, if an accurate mold is used, a composite of the optical element and the optical element holder with high position accuracy can be mass-produced with excellent productivity (See Japanese Laid-Open Patent Publication No. 2007-141416).

### CITATION LIST

### Patent Literature

PATENT LITERATURE 1: Japanese Laid-Open Patent Publication No. 2007-141416

### SUMMARY OF INVENTION

An optical element holder according to the present disclosure is an optical element holder for holding an optical element, wherein the optical element holder is formed from an optical element holder resin compound, the optical element holder resin compound contains a thermoplastic resin as a main component, a melting curve obtained by differential scanning calorimetry analysis of the optical element holder resin compound at a temperature increase rate of 10° C./min has two peaks in a range of not lower than 160° C. and not higher than 230° C. and a range of not lower than 260° C. and not higher than 320° C., and a ratio of a melting heat quantity in the range of not lower than 160° C. and not higher than 230° C. to a total melting heat quantity is not less than 20% and not greater than 80%.

An optical component according to the present disclosure is an optical component including: an optical element; and an optical element holder configured to hold the optical element by heat-welding, wherein the optical element holder is formed from an optical element holder resin compound, the optical element holder resin compound contains a thermoplastic resin as a main component, a melting curve obtained by differential scanning calorimetry analysis of the optical element holder resin compound at a temperature increase rate of 10° C./min has two peaks in a range of not lower than 160° C. and not higher than 230° C. and a range of not lower than 260° C. and not higher than 320° C., and a ratio of a melting heat quantity in the range of not lower than 160° C. and not higher than 230° C. to a total melting heat quantity is not less than 20% and not greater than 80%.

### BRIEF DESCRIPTION OF DRAWINGS

FIG. 1 is a diagram showing an example of a melting curve obtained by differential scanning calorimetry analysis in an example.

### DESCRIPTION OF EMBODIMENTS

### Problems to be Solved by the Present Disclosure

In recent years, along with the conversion of electronic components to surface mount components, a reflow method in which solder paste is printed on joint portions of a printed wiring board, then electronic components are mounted on the solder paste, the printed wiring board is sent to a reflow oven, and the solder is melted to join the electronic components, has been adopted. The optical components are mounted on various electronic devices by the reflow method. In the reflow method, lead-free solder having a high melting point is used from the viewpoint of environmental protection. As a result, the demand for heat resistance becomes higher, and heat resistance that maintains high rigidity at a temperature of about 260° C. in the reflow oven, that is, heat resistance to the reflow oven, is required for both the optical element holder and the optical element.

Therefore, as the optical element holder and for the optical element, an optical element holder made of a resin having a high melting point and softening point is used. However, when two-color molding is performed using thermoplastic resins having a large difference between a melting point and a softening point as the resins used for the optical element holder and the optical element, the adhesion between the optical element such as a lens or a mirror and the optical element holder is likely to be insufficient, and in particular, a gap between the lens and the optical element holder or peeling of the lens may be likely to occur.

The present disclosure has been made based on the above-described circumstances, and an object of the present disclosure is to provide an optical element holder that improves adhesiveness between an optical element and the optical element holder during two-color molding and that has high heat resistance that can withstand a reflow oven.

### Effects of the Present Disclosure

According to the present disclosure, it is possible to provide an optical element holder that improves adhesiveness between an optical element and the optical element holder during two-color molding and that has high heat resistance that can withstand a reflow oven.

### Description of Embodiments of the Present Disclosure

First, embodiments of the present disclosure will be listed and described.

An optical element holder according to the present disclosure is an optical element holder for holding an optical element, wherein the optical element holder is formed from an optical element holder resin compound, the optical element holder resin compound contains a thermoplastic resin as a main component, a melting curve obtained by differential scanning calorimetry analysis of the optical element holder resin compound at a temperature increase rate of 10° C./min has two peaks in a range of not lower than 160° C. and not higher than 230° C. and a range of not lower than 260° C. and not higher than 320° C., and a ratio of a melting heat quantity in the range of not lower than 160° C. and not higher than 230° C. to a total melting heat quantity is not less than 20% and not greater than 80%.

Since the optical element holder is formed from the optical element holder resin compound, the melting curve obtained by differential scanning calorimetry analysis of the optical element holder resin compound at a temperature increase rate of 10° C./min has two peaks in the above temperature ranges, and the ratio of the melting heat quantity in the range of not lower than 160° C. and not higher than 230° C. to the total melting heat quantity is within the above range, only the surface of the optical element holder is melted at the contact surface between the optical element holder and the optical element during two-color molding between the optical element holder and the optical element. Therefore, the optical element holder and the optical element are heat-welded in a state of having good adhesive strength while the shapes thereof are maintained. In addition, the optical element holder and the optical element have high heat resistance that can withstand a reflow oven. The above “optical element holder resin compound” in the present disclosure means a material forming the optical element holder after molding. Here, the “peak temperature” means a temperature at which an endothermic peak due to melting of the resin is indicated in the melting curve measured by differential scanning calorimetry (DSC). The “main component” refers to a component whose contained amount is the largest. The “total melting heat quantity” is the sum of the values of the melting heat quantity obtained from the area of each peak. The “heat-welding” is a technique to join thermoplastic resins together, and ultrasonic welding, high-frequency welding, etc., are also included in the heat-welding in a broad sense.

An optical component according to the present disclosure is an optical component including: an optical element; and an optical element holder configured to hold the optical element by heat-welding, wherein the optical element holder is formed from an optical element holder resin compound, the optical element holder resin compound contains a thermoplastic resin as a main component, a melting curve obtained by differential scanning calorimetry analysis of the optical element holder resin compound at a temperature increase rate of 10° C./min has two peaks in a range of not lower than 160° C. and not higher than 230° C. and a range of not lower than 260° C. and not higher than 320° C., and a ratio of a melting heat quantity in the range of not lower than 160° C. and not higher than 230° C. to a total melting heat quantity is not less than 20% and not greater than 80%.

Since the optical component includes the optical element and the optical element holder configured to hold the optical element by heat-welding, the optical element holder is formed from an optical element holder resin compound, the melting curve obtained by differential scanning calorimetry analysis of the optical element holder resin compound at a temperature increase rate of 10° C./min has two peaks in the above temperature ranges, and the ratio of the melting heat quantity in the range of not lower than 160° C. and not higher than 230° C. to the total melting heat quantity is within the above range, the optical element holder and the optical element are heat-welded in a state of having good adhesive strength while the shapes thereof are maintained. In addition, the optical element holder and the optical element have high heat resistance that can withstand a reflow oven.

### Details of Embodiments of the Present Disclosure

Hereinafter, an optical element holder and an optical component according to an embodiment of the present disclosure will be described in detail with reference to the drawing.

### <Optical Element Holder>

The optical element holder holds an optical element such as a mirror or a lens made of a resin. The optical element holder is formed from an optical element holder resin compound.

### (Optical Element Holder Resin Compound)

The optical element holder resin compound contains a thermoplastic resin as a main component. In addition, a melting curve obtained by differential scanning calorimetry analysis of the optical element holder resin compound at a temperature increase rate of 10° C./min has two peaks in a range of not lower than 160° C. and not higher than 230° C. and a range of not lower than 260° C. and not higher than 320° C. The melting curve is obtained by performing differential scanning calorimetry analysis under the following conditions. Using a differential scanning calorimeter, the temperature of 8 mg of a sample is increased from −50° C. to 350° C. at a temperature increase rate of 10° C./min under a nitrogen atmosphere. The melting heat quantity is obtained by calculating the area of each of the above two peaks. When a peak is multimodal, the melting heat quantity is obtained by calculating the area of the entire peak.

The lower limit of the ratio of the melting heat quantity in the range of not lower than 160° C. and not higher than 230° C. to the total melting heat quantity in the optical element holder resin compound is 20% and preferably 30%. The upper limit of the ratio of the melting heat quantity in the range of not lower than 160° C. and not higher than 230° C. to the total melting heat quantity in the optical element holder resin compound is 80% and preferably 70%. When the ratio of the melting heat quantity in the range of not lower than 160° C. and not higher than 230° C. to the total melting heat quantity is within the above range, only the surface of the optical element holder is melted at the contact surface between the optical element holder and the optical element during two-color molding between the optical element holder and the optical element. Therefore, the optical element holder and the optical element are heat-welded in a state of having good adhesive strength while the shapes thereof are maintained. In addition, the optical element holder and the optical element have high heat resistance that can withstand a reflow oven.

### <Thermoplastic Resin>

The optical element holder resin compound contains a thermoplastic resin as a main component. The thermoplastic resin preferably contains a thermoplastic resin that has a peak in a range of not lower than 160° C. and not higher than 230° C. in a melting curve obtained by differential scanning calorimetry analysis at a temperature increase rate of 10° C./min, and a thermoplastic resin that has a peak in a range of not lower than 260° C. and not higher than 320° C. in a melting curve obtained by differential scanning calorimetry analysis at a temperature increase rate of 10° C./min.

Examples of the thermoplastic resin that has a peak in the range of not lower than 160° C. and not higher than 230° C. include a polyamide (melting point: 176° C.) obtained by ring-opening polycondensation of lauryl lactam commercially available under a trade name such as Nylon 12, and a polyamide (melting point: 187° C.) obtained by ring-opening polycondensation of undecane lactam commercially available under a trade name such as Nylon 11.

Examples of the thermoplastic resin that has a peak in the range of not lower than 260° C. and not higher than 320° C. include a polyamide (melting point: 308° C.) commercially available under a trade name such as Nylon 9T and containing nonane diamine and terephthalic acid as main components, a polyamide (melting point: 290° C.) commercially available under a trade name such as Nylon 46 and containing butane diamine and adipic acid as main components, and a polyamide (melting point: 285° C.) commercially available under a trade name such as Nylon 10T and containing decane diamine and terephthalic acid as main components.

The lower limit of the content ratio of the thermoplastic resin that has a peak in the range of not lower than 160° C. and not higher than 230° C. in the above thermoplastic resin is preferably 20 mass % and more preferably 30 mass %. On the other hand, the upper limit of the content ratio of the thermoplastic resin that has a peak in the range of not lower than 160° C. and not higher than 230° C. is preferably 80 mass % and more preferably 70 mass %.

The lower limit of the contained amount of the above thermoplastic resin in the optical element holder resin compound is preferably 30 mass % and more preferably 40 mass %. On the other hand, the upper limit of the contained amount of the above thermoplastic resin is, for example, 99 mass %. However, the contained amount of the thermoplastic resin may be 100 mass %. If the contained amount of the thermoplastic resin is less than the lower limit, the dimensional stability of the optical element holder may be insufficient.

The optical element holder resin compound is preferably crosslinked. When the optical element holder resin compound is crosslinked, the thermal resistance and the mechanical strength of the optical element holder can be improved.

### (Additives)

The optical element holder resin compound preferably contains a filler and a crosslinking agent as additives. When the optical element holder resin compound contains a filler, the dimensional stability in the reflow oven of the optical element holder joined to the optical element is improved. In addition, when the optical element holder resin compound contains a crosslinking agent, crosslinking can be accelerated.

Examples of the filler include glass fibers, inorganic whiskers such as basic magnesium sulfate whiskers, zinc oxide whiskers, and potassium titanate whiskers, inorganic fillers such as montmorillonite, synthetic smectite, alumina, and carbon fibers, organic materials such as cellulose, kenaf, and aramid fibers, and organic clay. Among these fillers, glass fibers are preferable from the viewpoint of improving the dimensional stability in the reflow oven of the optical element holder joined to the optical element.

When the optical element holder resin compound contains an inorganic filler, the lower limit of the contained amount of the inorganic filler per 100 parts by mass of the thermoplastic resin is preferably 10 parts by mass and more preferably 20 parts by mass. On the other hand, the upper limit of the contained amount of the inorganic filler per 100 parts by mass of the thermoplastic resin is preferably 100 parts by mass and more preferably 80 parts by mass. If the contained amount of the inorganic filler is less than the lower limit, the dimensional stability in the reflow oven of the optical element holder joined to the optical element may become insufficient. On the other hand, if the contained amount of the inorganic filler exceeds the upper limit, molding of the optical element holder may be difficult.

Examples of the crosslinking agent include:

oximes such as p-quinone dioxime and p,p′-dibenzoylquinone dioxime;

acrylates or methacrylates such as ethylene dimethacrylate, polyethylene glycol dimethacrylate, trimethylolpropane triacrylate (TMPTA), trimethylolpropane trimethacrylate, cyclohexyl methacrylate, an acrylic acid/zinc oxide mixture, and allyl methacrylate;

vinyl monomers such as divinylbenzene;

allyl compounds such as hexamethylene diallyl nadimide, diallyl itaconate, diallyl phthalate, diallyl isophthalate, diallyl monoglycidyl isocyanurate (DA-MGIC), triallyl cyanurate, and triallyl isocyanurate (TAIC); and

maleimide compounds such as N,N′-m-phenylene bismaleimide and N,N′-(4,4′-methylenediphenylene)dimaleimide.

As the crosslinking agent, TMPTA, DA-MGIC, and TAIC are preferable from the viewpoint of effectively accelerating a crosslinking reaction.

When the optical element holder resin compound contains the crosslinking agent, the lower limit of the contained amount of the crosslinking agent per 100 parts by mass of the thermoplastic resin is preferably 1 part by mass and more preferably 3 parts by mass. On the other hand, the upper limit of the contained amount of the crosslinking agent per 100 parts by mass of the thermoplastic resin is preferably 15 parts by mass and more preferably 10 parts by mass. If the contained amount of the crosslinking agent is less than the lower limit, the crosslink density of the optical element holder may be decreased, and sufficient dimensional stability may not be obtained. On the other hand, if the contained amount of the crosslinking agent exceeds the upper limit, the effect of further accelerating the crosslinking reaction may not be obtained.

As long as the effects of the present disclosure are not impaired, the optical element holder resin compound can contain other additive components other than the inorganic filler and the crosslinking agent, for example, an antioxidant, an ultraviolet absorber, a visible light absorber, a weather resistance stabilizer, a copper inhibitor, a flame retardant, a lubricant, a conductive agent, a plating agent, a colorant, etc.

When the optical element holder resin compound contains other additives other than the inorganic filler and the crosslinking agent, the total contained amount of the other additives per 100 parts by mass of the thermoplastic resin can be, for example, greater than 0 parts by mass and not greater than 10 parts by mass.

### [Method for Manufacturing Optical Element Holder]

A method for manufacturing the optical element holder preferably includes a step of molding a molding resin compound containing the above thermoplastic resin and optional additives such as a filler and a crosslinking agent, and a step of crosslinking the molded resin compound. Hereinafter, each step will be described.

### (Molding Step)

In this step, the molding resin compound containing the above thermoplastic resin and optional additives such as a filler and a crosslinking agent is molded. The above optical element holder resin compound can be produced by premixing the thermoplastic resin and optional components added as necessary with a super mixer or the like, and then melt-kneading the mixture using a single-screw mixer, a twin-screw mixer, or the like. The specific temperature of the melt-kneading is, for example, not lower than 180° C. and not higher than 360° C.

The method for molding the optical element holder resin compound is not particularly limited, and examples thereof include an injection molding method, an extrusion molding method, and a compression molding method. Among these methods, the injection molding method is preferable. When the optical element holder resin compound is molded by the injection molding method, the molding conditions can be, for example, a barrel temperature of not lower than 200° C. and not higher than 300° C., an injection pressure of not less than 20 kg/cm′ and not greater than 3,000 kg/cm², a pressure-holding time of not shorter than 3 seconds and not longer than 30 seconds, and a mold temperature of not lower than 30° C. and not higher than 100° C.

### (Crosslinking Step)

In this step, the above optical element holder resin compound is crosslinked. Examples of the crosslinking method include electron beam crosslinking by irradiation with an electron beam and thermal crosslinking by heating. Crosslinking by irradiation with an electron beam is preferable since restrictions on the temperature and fluidity during molding are not involved and control of crosslinking is easy. From the viewpoint of obtaining heat resistance, the irradiation dose of the electron beam can be, for example, not less than 10 kGy and not greater than 1000 kGy.

The optical element holder improves the adhesiveness between the optical element and the optical element holder during two-color molding and also has high heat resistance that can withstand the reflow oven.

### <Optical Component>

The optical component includes an optical element and an optical element holder which holds the optical element by heat-welding.

The optical component is suitably used as an optical connector for connecting an optical cable. The optical component is suitably used, for example, as an optical element such as a light-emitting element and a light-receiving element in a device equipped with a light-emitting/receiving element such as an optical communication device, an optical pickup in an optical recording/reproduction device, and an LED (light-emitting diode) lens package, etc., for example, for various electronic devices such as a car navigation system, a CD, a MD, a DVD, an image sensor, a camera module, an IR sensor, a motion sensor, and a remote control.

### [Optical Element]

Examples of the optical element include a lens and a mirror. The lens and the mirror used in the optical component are required to be transparent. In the case of a sensor or communication application, the transmittance for light generated from a light-emitting element such as LEDs, VCSELs (vertical resonator surface emitting lasers), other lasers, and silicon photonics having wavelengths of 650 nm, 850 nm, 1300 nm, etc., at a thickness of 1 mm is required to be 80% or more. In addition, for applications such as photography and surveillance, a transmittance of 80% or more is required in the entire visible light range. Therefore, the resin that forms the optical element is preferably selected from transparent resins that can achieve this transmittance. Here, the transmittance is an index representing transparency, is measured by using the measurement method specified in JIS-K7361 (1997), and is a value indicated by a percentage of the ratio of the amount of incident light to the total amount of light passing through a test piece for light of a predetermined wavelength.

As the resin forming the optical element, for example, polyetherimides, thermoplastic polyimides, transparent polyamides, cyclic polyolefins, transparent fluorine resins, transparent polyesters, polycarbonates, polystyrenes, acrylic resins, transparent polypropylenes, ethylene ionomers, fluorine-based ionomers, etc., are preferable.

### [Optical Element Holder]

The optical element holder holds the optical element by heat-welding. The specific configuration of the optical element holder is as described above for the optical element holder, and thus the description thereof is omitted. The shape of the optical element holder is not particularly limited, and can be appropriately changed according to an electronic device on which the optical element holder is to be mounted.

### [Method for Manufacturing Optical Component]

The optical component is manufactured by two-color molding. The two-color molding is a molding method in which two types of resins are heat-welded in one molding machine, and stable product quality can be obtained. In two-color molding, two types of materials having different material qualities are usually molded with one mold. For example, after an optical element holder of either one of an optical element or an optical element holder is obtained, the optical element holder is mounted in a mold, and a resin for forming the other is melted, injection-molded in the space (cavity) of the mold, and then, for example, cooled to be solidified, whereby a composite of the optical element and the optical element holder is obtained. For the optical component, preferably, after the optical element holder and the optical element are heat-welded by two-color molding, the resins may be crosslinked together by irradiating the integrated optical element holder with an electron beam or the like.

Since the optical component includes the optical element holder, the optical component has good adhesive strength between the optical element holder and the optical element, and has high heat resistance that can withstand the reflow oven.

### Other Embodiments

The embodiments disclosed herein are illustrative in all aspects and should not be recognized as being restrictive. The scope of the present disclosure is not limited to the configuration of the above embodiment, but is defined by the scope of the claims and is intended to include meaning equivalent to the scope of the claims and all modifications within the scope.

### Examples

Hereinafter, the present disclosure will be described in more detail by way of examples, but the present invention is not limited to the examples.

### [Test No. 1 to Test No. 10]

### (1) Production of Optical Element Holder

An optical element holder resin compound was prepared by blending 5 parts by mass of a crosslinking agent and 30 parts by mass of a glass fiber in 100 parts by mass of a thermoplastic resin blended according to a formula shown in Table 1. Next, the optical element holder resin compound was injection-molded to form a cylindrical optical element holder having an outer diameter of 10 mm and an inner diameter of 6 mm.

The thermoplastic resins and the crosslinking agent used for the optical element holder resin compound are as follows.

Nylon 9T: Genestar G1300A (manufactured by Kuraray Co., Ltd., polyamide 9T, melting point: 308° C.)

Nylon 46: Stanyl TW241 manufactured by DSM (polyamide 46, melting point: 290° C.)

Nylon 12: UBE Nylon 3024U (manufactured by Ube Industries, Ltd., polyamide 12, melting point: 176° C.)

Triallyl isocyanurate (manufactured by Mitsubishi Chemical Corporation)

In Table 1, “-” indicates the case where each material was not used.

### (2) Production of Optical Component (Two-Color Molding)

After the optical element holder was produced, the mold was heated to about 80° C., and a thermoplastic resin compound transparent polyamide for a lens was injected into the inner space of the mold. Then, cooling was performed to obtain an optical component in which a lens having an outer diameter of 6 mm and a central thickness of 1 mm and the optical element holder were integrated. The optical component thus obtained was crosslinked by irradiation with an electron beam of 600 kGy to produce an optical component.

### [Evaluation]

The optical components of Test No. 1 to Test No. 10 thus obtained were evaluated by the following methods. The results are shown in Table 1 below.

### (Measurement of Melting Heat Quantity)

The melting temperature and melting heat quantity were determined by performing DSC measurement under the following conditions.

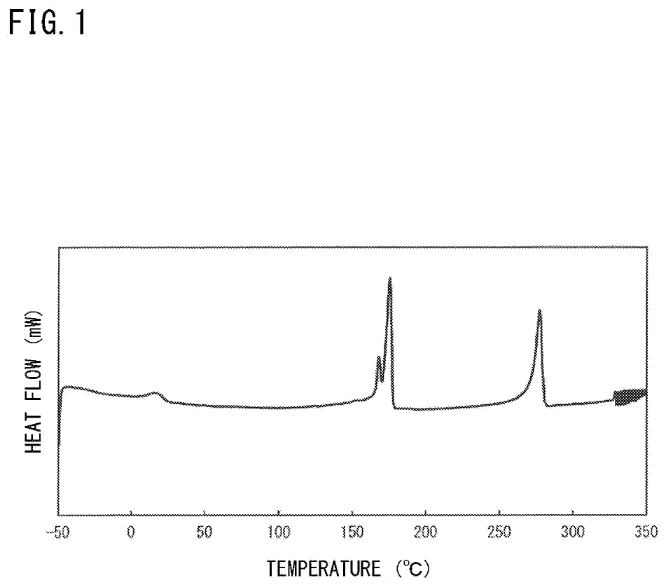

Using a differential scanning calorimeter (trade name: DSC8500, manufactured by PerkinElmer), the temperature of 8 mg of a sample was increased from −50° C. to 350° C. at a temperature increase rate of 10° C./min under a nitrogen atmosphere. The temperature at which the two endothermic peaks observed during this temperature increase appeared was determined as the melting temperature. The melting heat quantity was obtained by calculating the area of each of the above two peaks. When a peak was multimodal, the melting heat quantity was obtained by calculating the area of the entire peak. FIG. 1 shows an example of the melting curve of Test No. 2.

### (Adhesiveness)

The interface between the lens and the optical element holder was visually inspected, and the adhesiveness between the lens and the optical element holder was determined based on the presence/absence of peeling.

### (Surface Property of Adhesive Surface)

The interface that is the adhesive surface between the lens and the optical element holder was visually inspected, and the surface property of the adhesive surface of the optical element holder was determined based on the presence/absence of deformation of the interface of the optical element holder.

### (Heat Resistance)

The optical element holder was placed in a reflow oven at 260° C. for 10 minutes, and the heat resistance of the optical element holder was determined based on the presence/absence of deformation of the optical element holder.

TABLE 1

| Test No. | | 1 | 2 | 3 | 4 | 5 | 6 | 7 | 8 | 9 | 10 |
|---|---|---|---|---|---|---|---|---|---|---|---|
| Optical | Nylon 9T content | 50 | — | 30 | — | 80 | — | 10 | 90 | 100 | — |
| element | ratio (mass %) | | | | | | | | | | |
| holder resin | Nylon 46 content | — | 50 | — | 30 | — | 70 | — | — | — | 100 |
| composition | ratio (mass %) | | | | | | | | | | |
| | Nylon 12 content | 50 | 50 | 70 | 70 | 20 | 30 | 90 | 10 | — | — |
| | ratio (mass %) | | | | | | | | | | |
| DSC | Presence/absence | Pres- | Pres- | Pres- | Pres- | Pres- | Pres- | Pres- | Pres- | Only | Only |
| measurement | of two peaks in | ence | ence | ence | ence | ence | ence | ence | ence | one | one |
| | melting curve by DSC | | | | | | | | | peak | peak |
| | Melting heat quantity | 53 | 56 | 79 | 76 | 22 | 32 | 94 | 12 | 0 | 0 |
| | at 160° C. or higher | | | | | | | | | | |
| | and 230° C. or | | | | | | | | | | |
| | lower/total melting | | | | | | | | | | |
| | heat quantity (%) | | | | | | | | | | |
| Evaluation | Adhesiveness between | No | No | No | No | No | No | No | With | With | With |
| | lens and optical | peeling | peeling | peeling | peeling | peeling | peeling | peeling | peeling | peeling | peeling |
| | element holder | | | | | | | | | | |
| | Surface property of | No in- | No in- | No in- | No in- | No in- | No in- | With in- | No in- | No in- | No in- |
| | adhesive surface of | terface | terface | terface | terface | terface | terface | terface | terface | terface | terface |
| | optical element | defor- | defor- | defor- | defor- | defor- | defor- | defor- | defor- | defor- | defor- |
| | holder | mation | mation | mation | mation | mation | mation | mation | mation | mation | mation |
| | Heat resistance of | No | No | No | No | No | No | With | No | No | No |
| | optical element | holder | holder | holder | holder | holder | holder | holder | holder | holder | holder |
| | holder | defor- | defor- | defor- | defor- | defor- | defor- | defor- | defor- | defor- | defor- |
| | | mation | mation | mation | mation | mation | mation | mation | mation | mation | mation |

As shown in Table 1, the adhesiveness, the surface property of the adhesive surface, and the heat resistance were all good in the optical element holders of Test No. 1 to Test No. 6 for which the melting curve obtained by DSC of the optical element holder resin compound has two peaks in a range of not lower than 160° C. and not higher than 230° C. and a range of not lower than 260° C. and not higher than 320° C., and the ratio of the melting heat quantity in the range of not lower than 160° C. and not higher than 230° C. to the total melting heat quantity is not less than 20% and not greater than 80%. On the other hand, any of the adhesiveness, the surface property of the adhesive surface, and the heat resistance was inferior in the optical element holder of Test No. 7 to Test No. 10 which do not satisfy the above requirements.

From the above results, it is shown that the optical element holder improves the adhesiveness between the optical element holder and the optical element during two-color molding, and has high heat resistance that can withstand a reflow oven.

1. An optical element holder for holding an optical element, wherein
the optical element holder is formed from an optical element holder resin compound,
the optical element holder resin compound contains a thermoplastic resin as a main component, and
a melting curve obtained by differential scanning calorimetry analysis of the optical element holder resin compound at a temperature increase rate of 10° C./min has two peaks in a range of not lower than 160° C. and not higher than 230° C. and a range of not lower than 260° C. and not higher than 320° C., and a ratio of a melting heat quantity in the range of not lower than 160° C. and not higher than 230° C. to a total melting heat quantity is not less than 20% and not greater than 80%.

2. An optical component comprising:
an optical element; and
an optical element holder configured to hold the optical element by heat-welding, wherein
the optical element holder is formed from an optical element holder resin compound,
the optical element holder resin compound contains a thermoplastic resin as a main component, and
a melting curve obtained by differential scanning calorimetry analysis of the optical element holder resin compound at a temperature increase rate of 10° C./min has two peaks in a range of not lower than 160° C. and not higher than 230° C. and a range of not lower than 260° C. and not higher than 320° C., and a ratio of a melting heat quantity in the range of not lower than 160° C. and not higher than 230° C. to a total melting heat quantity is not less than 20% and not greater than 80%.
